(19) United States
(12) Patent Application Publication
(10) Pub. No.: US 2022/0034422 A1
(43) Pub. Date: Feb. 3, 2022

(54) AN INTEGRATED SYSTEM FOR DETERMINING PLUNGER POSITION IN A SOLENOID VALVE AND METHOD THEREFORE

(71) Applicant: Padmini VNA Mechatronics Pvt. Ltd., Udyog Vihar, Gurgaon, Haryana (IN)

(72) Inventors: Kabir BHANDARI, Udyog Vihar, Gurgaon, Haryana (IN); Torsten GERLICH, Udyog Vihar, Gurgaon, Haryana (IN); Amardip KUMAR, Udyog Vihar, Gurgaon, Haryana (IN); Nitin MANHAS, Udyog Vihar, Gurgaon, Haryana (IN); Ghanshyam SWARNKAR, Udyog Vihar, Gurgaon, Haryana (IN); Deepak NIRANKARI, Udyog Vihar, Gurgaon, Haryana (IN)

(73) Assignee: Padmini VNA Mechatronics Pvt. Ltd., Udyog Vihar, Gurgaon, Haryana (IN)

(21) Appl. No.: 17/279,761

(22) PCT Filed: May 6, 2019
(86) PCT No.: PCT/IB2019/053676

§ 371 Date: Mar. 25, 2021

(30) Foreign Application Priority Data
May 4, 2018 (IN) 201811017006

(51) Int. Cl. F16K 37/00; H01F 7/08; H01F 7/16

(52) U.S. Cl. CPC F16K 37/0033; H01F 7/16; H01F 7/081

(57) ABSTRACT

The present invention provides a system for determining plunger position in a solenoid valve and method therefore. More specifically, the invention provides a solenoid valve having hall sensor for detection of plunger position, which provides feedback including output voltage (digital or analog) respective to its position. The solenoid valve includes a nozzle, a spring, a sealing rubber, a poppet, a magnetic bracket, a rubber grommet, a housing sub-assembly, a soft seal, a sensor assembly, a fix core, a moving core and/or plunger, coil, a bobbin sub-assembly, a fix core plate, magnet holder, a permanent magnet and plurality of terminals.

### FIELD OF THE INVENTION

The present invention provides a system for determining plunger position in a solenoid valve and method therefore. More specifically, the invention provides a solenoid valve having a hall sensor for detection of plunger position, which provides feedback including output voltage (digital or analog) respective to its position.

### BACKGROUND OF THE INVENTION

One of the major source of automotive hydrocarbon emission is the fuel system, from which hydrocarbons are emitted through fuel tank and carburetor vents. When the engine is turned off and the engine heat warms up the fuel system, gasoline is evaporated and emitted to the atmosphere. In addition, heating during the day or cooling at night causes the fuel tank to breathe and emit gasoline fumes. The efforts to control such emissions are majorly focused towards reducing volatility by modifying formulation. Further, the automobiles are equipped with canisters of carbon, which collect the evaporated fuel from the fuel tank and fuel system, to be purged and burned when the engine is operating.

All vehicles are provided with an Evaporative Emission Control (EVAP) system. The EVAP system prevents fuel vapors in the fuel tank from escaping into the atmosphere. Further, the EVAP system traps fuel vapors from the fuel tank and temporarily stores them in the charcoal canister. In these systems, a solenoid valve is arranged in the breather pipe connecting the upper interior of the fuel tank to the charcoal canister, and this solenoid valve, which is normally closed, is opened when the fuel tank is replenished.

Solenoid valves are electromagnetically operated valve, which opens or closes when the current is applied and the fluid passed. The Electromechanical solenoids comprise of an electromagnetically inductive coil, wound around a movable steel or iron slug (termed the armature). The coil is shaped such that the armature can be moved in and out of the center, altering the coil's inductance and thereby becoming an electromagnet. The armature is used to provide a mechanical force to some mechanism (such as controlling mechanism for a pneumatic valve). Although, such solenoids typically work in controlling anything but majorly over very short distances, and thus have very quick reaction times, which are controlled directly by a controller circuit.

Many solenoid valves of this type do not provide a means for determining the actual condition of the actuator. In other words, when an electric current is provided to the coil of the solenoid to move the plunger toward one position or the other, no means is readily available to determine if the plunger actually responded to the magnetic field. In solenoid valve which are configured to provide a reciprocating capability, wherein an actuation of the solenoid causes the plunger to move into a first and in a second position after the solenoid coil is deactivated, it is particularly important to be able to determine the actual position of the plunger. The means for determining the actual position of the plunger is important because several malfunctions can possibly cause the plunger to be in a position other than that which is intended. For example, the solenoid coil may not actually have been actuated by the anticipated flow of current through its conductor. This could be caused by a broken wire or a disconnection in the electrical circuit of the solenoid. Even if the solenoid operates properly and the plunger moves in the intended direction, a subsequent shock to the apparatus could possibly cause harm to any of the integral part which leads to un-proper functioning of system.

Therefore, as we can deduce from the current state of art that, such malfunctions can hinder the proper functioning of typical solenoid valve and consequently defeat the purpose of EVAP system. Accordingly, there is a need for a mechanism for providing feedback to the vehicle system regarding the actual operational state of the pin or plunger of the solenoid valve during persistent and continuous operation.

### OBJECT OF THE INVENTION

The main object of the invention is to provide a solenoid valve incorporated with at least one hall sensor for providing feedback of plunger including position and output voltage (digital or analog).

Yet another object of the invention is to identify the different position of the solenoid valve's plunger in different operating mode such as ON, OFF, defined stroke or the failure state.

Yet another object of the invention is to customize a solenoid valve to give feedback signal as required, i.e. not limited to fixed magnitude, it is fed to the sensing system until and unless meets specification.

Yet another object of the invention is to introduce the incorporation of a magnet inside a plunger of a solenoid valve.

Yet another object of the invention is to introduce an improved poppet design in order to vent the air pocket stuck inside the solenoid valve during assembly process.

Yet another object of the invention is to reduce overall manufacturing cost of a solenoid valve by implementation a soft seal.

### SUMMARY OF THE INVENTION

The present invention provides a solenoid valve for vehicle system with integrated position feedback system for plunger movement. More specifically, the invention provides a solenoid valve having at least one hall sensor for detection of plunger position, which provides feedback in terms of output voltage (digital or analog) respective to its position.

In an embodiment of the present invention, the solenoid valve includes a nozzle, a spring, a sealing rubber, a poppet, a magnetic bracket, a rubber grommet, a housing sub-assembly, a soft seal, a sensor assembly, a fix core, a moving core and/or plunger, coil, a bobbin sub-assembly, a fix core plate, magnet holder, a permanent magnet and plurality of terminals.

In another embodiment of the present invention, a molded nozzle having an inlet and outlet is provided for connecting the respective hoses. The nozzle is made up of material such as, but not limited to like thermoplastics, PVC, PUC, etc. Further, an over molded housing sub-assembly made up of material such as, but not limited to thermoplastics, PVC, PUC, etc., enclosing bobbin sub-assembly and sensor sub-assembly is provided to which molded nozzle gets attached using methods such as, but not limited to like ultrasonic welding, etc. Over the housing sub-assembly a rubber grommet is provided for mounting the solenoid valve.

In another embodiment of the present invention, a bobbin sub-assembly for a solenoid valve coil is provided that includes a bobbin formed from an electrically insulated material such as, thermoplastics, nylon, etc., with a bore extending axially. Further, a metallic coil or conducting material such as copper is then wound or wrapped around the bobbin, which when energized sets up a magnetic field. The coil with bobbin is put inside a magnetic bracket and crimped to fix core plate to form a coil assembly and to provide a sustainable magnetic path. Further, at the one end of bobbin, terminal pins are connected within bobbin to which coil's end are connected for receiving electrical input.

In another embodiment of the present invention, the provided fix core is assembled into the inner diameter of bobbin and gets magnetized when coil is energized, a moving core and/or plunger is provided which selectively opens and closes the supply of air into the valve upon energization and de-energization, a sealing rubber made up of material such as, but not limited to like teflon, PU, etc. is provided which under energized condition, blocks the air flow, a spring is provided to reset the poppet position on de-energization. Further, the moving core and/or plunger is assembled inside the inner diameter of bobbin and attracted to a fix core which drives the poppet in one direction. When the coil is de-energized, the moving core and/or is separated from the fix core by a return spring to return the valve member in the opposite direction. A magnet holder is press fitted to the moving core and/or plunger and encapsulates a permanent magnet.

In another embodiment of the present invention, a poppet is provided made up of material such as, but not limited to like thermoplastic, etc. The poppet having a circular shaft has plurality of flat surface across its length to assist the venting of air pocket locked inside the solenoid valve during assembly, thus keeping the function smooth and accurate.

In another embodiment of the present invention, a sensor sub-assembly for a solenoid valve coil is provided that includes a hall sensor and electronics auxiliaries. Sensor sub-assembly is attached on housing sub-assembly by soldering it with the terminals and filled with soft seal made up of material, such as but not limited to like rubber, silicone, etc. for protecting it from vibration and external environmental conditions only.

In another embodiment of the present invention, the provided permanent magnet which is serving as sensor magnet is assembled inside the plunger's inner diameter. Further a hall sensor of rated voltage such as, but not limited to like 5 VDC is attached on the housing which detects the moving core and/or plunger position as it moves through stroke length and provides feedback in terms of output voltage (digital or analog) respective to its position.

In another embodiment of the present invention, the overall cost of solenoid valve is reduced by replacing end cap and epoxy with a soft seal which protects the sensor sub-assembly from vibration and external environmental conditions.

In another embodiment of the present invention, enables to identify different operating mode and detecting the position of the solenoid valve's plunger, i.e. ON State, OFF State, defined stroke or the failure state.

In another embodiment of the present invention, the different operating modes of operations are specified as:

On State: This state defines the valve with energized condition at full rated voltage. In this state in terms of pneumatic condition, the valve is either open or closed.

OFF State: This state defines the valve at de-Energized condition and characterize with lower rated voltage. In this state in terms of pneumatic condition, the valve is either open or closed.

Defined Stroke: This state defines the condition of the plunger in between ON & OFF state and accordingly has rated voltages in between full and lower rate. As per requirement, a position is defined in the design. This state is not necessary in valve until & unless required.

Failure State: This state defines the undesired condition of plunger position, for example zero plunger movement or plunger getting stuck and characterized with the least voltage.

In another embodiment of the present invention, the solenoid valve is programmed to give feedback signal as per requirement, i.e. not limited to fixed magnitude, it is fed to the sensing system until and unless meets specification.

In another embodiment of the present invention, the provided arrangement smartly detects the failure of the valve in case of plunger getting stuck.

In another embodiment of the present invention, the provided arrangement gives add-on feature of getting real time status of valve without any external sensor.

In another embodiment of the present invention, the provided arrangement enables EVAP System for its dynamic type of position signals (digital or analog) capability.

### BRIEF DESCRIPTION OF THE DRAWINGS

The object of the invention may be understood in more details and more particularly description of the invention briefly summarized above by reference to certain embodiments thereof which are illustrated in the appended drawings, which drawings form a part of this specification. It is to be noted, however, that the appended drawings illustrate preferred embodiments of the invention and are therefore not to be considered limiting of its scope, for the invention may admit to other equally effective equivalent embodiments.

FIG. 1 shows the sectional view of a solenoid valve in accordance with an embodiment of the present invention;

FIG. 2 shows the exploded view of a solenoid valve in accordance with an embodiment of the present invention;

FIG. 3 shows the exploded view of a bobbin sub-assembly in accordance with an embodiment of the present invention;

FIGS. 4A and 4B shows the improved design poppet in accordance with an embodiment of the present invention; and

FIG. 5 shows position feedback characteristics of a solenoid valve in accordance with an embodiment of the present invention.

### DESCRIPTION OF THE INVENTION

The present invention will now be described more fully hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art.

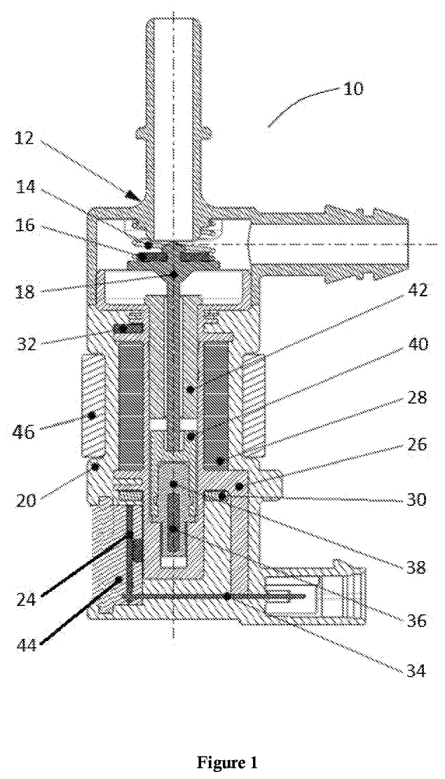

FIG. 1 shows a sectional view of a solenoid valve 10 comprising, a nozzle 12 for connecting inlet-outlet hoses, a poppet 18 fitted with a sealing rubber 16, a spring 14 is provided over sealing rubber 16 which resets poppet 18 on de-energization. Nozzle 12 is attached to a housing sub-assembly 20 which incorporate a bobbin sub-assembly 22 and sensor sub-assembly 24. Bobbin sub-assembly 22 comprises of a bobbin 26 formed from an electrically insulated material with a through bore extending axially up to the bottom to which a coil 28 of copper material is wound. At the closing face of bobbin 26, a fix core plate 30 is attached and coil 28 with bobbin 26 is put inside a magnetic bracket 32 which is crimped to fix core plate 30. Further, at the one end, terminal pins 34 are connected with in bobbin 26 to which coil's 28 end are connected for receiving electrical input. A permanent magnet 36 is encapsulated inside magnet holder 38 which is press fitted into the inner diameter of moving core and/or plunger 40. A poppet 18 is inserted into moving core and/or plunger 40. A fix core 42 having a guide hole for poppet 18 is fixed at the open end of bobbin 26. A sensor sub-assembly 24 is fixed over the housing sub-assembly 20 for detection of moving core and/or plunger 40 position, which provides feedback in terms of output voltage (digital or analog) respective to its position. Sensor sub-assembly 24 is secured with a soft seal 44 filled in the housing sub-assembly 20. The soft seal 44 protects the sensor sub-assembly 24 from possible external damages and a rubber grommet 46 is provided for mounting the solenoid valve 10.

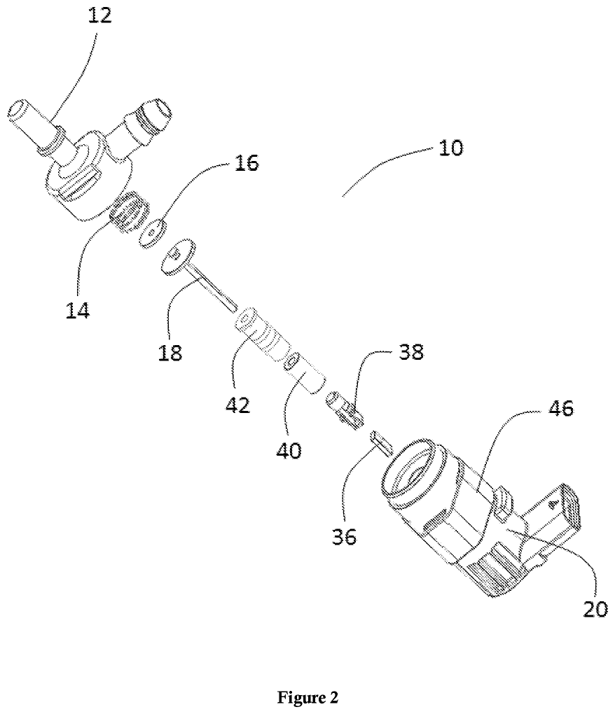

FIG. 2 shows the exploded view of a solenoid valve 10 comprising a nozzle 12 for connecting inlet-outlet hoses, a poppet 18 fitted with a sealing rubber 16, a spring 14 is provided over sealing rubber 16 which resets poppet 18 on de-energization. Nozzle 12 is attached to a housing sub-assembly 20. A permanent magnet 36 is encapsulated inside magnet holder 38 which is press fitted into the inner diameter of moving core and/or plunger 40. A poppet 18 is inserted into moving core and/or plunger 40. A fix core 42 having a guide hole for poppet 18 is fixed at the open end of bobbin 26. A rubber grommet 46 is provided for mounting the solenoid valve 10.

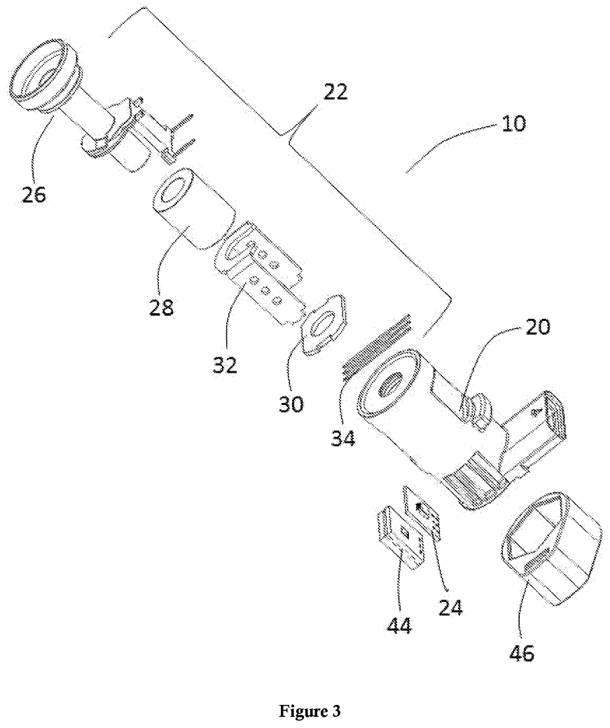

FIG. 3 shows the exploded view of a bobbin sub-assembly 22 of a solenoid valve 10 comprising, a bobbin 26 formed from an electrically insulated material with a through bore extending axially up to the bottom to which a coil 28 of copper material is wound. At the closing face of bobbin 26 a fix core plate 30 is attached and coil 28 with bobbin 26 is put inside a magnetic bracket 32 which is crimped to fix core plate 30. Further, at the one end, terminal pins 34 are connected with in bobbin 26 to which coil's 28 end are connected for receiving electrical input. A sensor sub-assembly 24 is fixed over the housing sub-assembly 20 for detection of moving core and/or plunger 40 position, which provides feedback in terms of output voltage (digital or analog) respective to its position. Sensor sub-assembly 24 is secured with a soft seal 44 filled in the housing sub-assembly 20. The soft seal 44 protects the sensor sub-assembly 24 from possible external damages and a rubber grommet 46 is provided for mounting the solenoid valve 10.

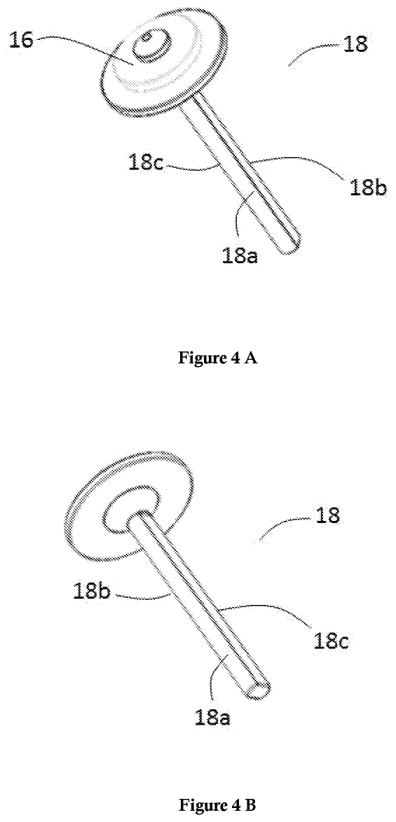

FIGS. 4A and 4B shows the poppet 18 with sealing rubber 16 on the top of it. The poppet's circular shaft 18a has plurality of flat surface 18b and 18c across its length to assist the venting of air pocket locked inside the solenoid valve during assembly thus keeping the function smooth and accurate.

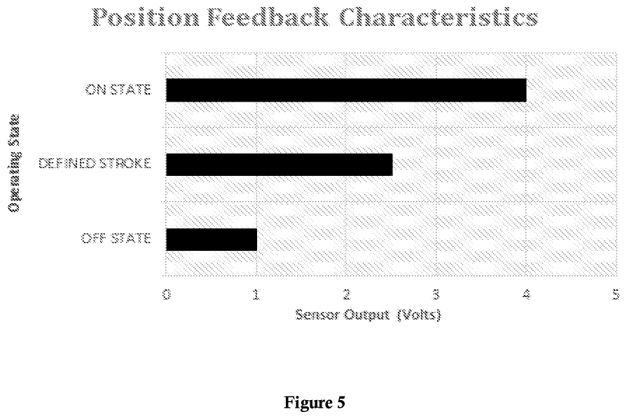

FIG. 5 shows position feedback characteristics of a solenoid valve 10 highlighting different operating modes as follows:

On State: This state defines the valve with energized condition at full rated voltage. In this state in terms of pneumatic condition, the valve is either open or closed.

OFF State: This state defines the valve at de-Energized condition and characterize with lower rated voltage. In this state in terms of pneumatic condition, the valve is either open or closed.

Defined Stroke: This state defines the condition of the plunger in between ON & OFF state and accordingly has rated voltages in between full and lower rate. As per requirement, a position is defined in the design. This state is not necessary in valve until & unless required.

Failure State: This state defines the undesired condition of plunger position, for example zero plunger movement or plunger getting stuck and characterized with the least voltage.

In a de-energized state, the solenoid valve is in OFF state, and no electric current is provided to the coil of the solenoid, hence there is no change in position of plunger fitted with permanent magnet. Therefore, the hall sensor in the sensor assembly provides feedback in terms of voltage in the range of like 0.5V-1.5V. However, this feedback in terms of voltage may vary in different applications.

In an energized state, an electric current is provided to the coil of the solenoid valve and the solenoid valve turns to ON state. As the solenoid valve is energized, it will move the plunger fitted with permanent magnet toward one position or the other. Therefore the face of the magnet and hall sensor position changes resulting into fluctuation of magnetic field that is sensed by the hall sensor. The hall sensor then provides feedback in terms of voltage in the range of like 3.5V-4.5V. However, this feedback in terms of voltage may vary in different applications. When the solenoid valve is in actual working condition, the hall sensor keeps on detecting position of plunger as soon as there is a fluctuation in magnetic field. The permanent magnet is incorporated in the plunger such that permanent magnet and hall sensor are parallel to each other for detection of the position of plunger.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

We claim:

1. A solenoid valve (10) with an integrated position feedback system for detection of position of plunger (40) comprising of:
a nozzle (12), a spring (14), a sealing rubber (16), a poppet (18), a rubber grommet (46), a housing sub-assembly (20) incorporating a bobbin sub assembly (22) and sensor sub-assembly (24), a soft seal (44), a fix core (42), a moving core and/or plunger (40), coil (28), magnet holder (38), a permanent magnet (36),
wherein,
said bobbin sub-assembly (22) comprises of a bobbin (26), a coil (28), a fix core plate (30), a magnetic bracket (32), and a plurality of terminal pins (34);
said sensor sub-assembly (24) comprises of a hall sensor and a plurality of electronic auxiliaries;
said sensor sub-assembly is secured with said soft seal (44) filled in said housing sub-assembly (20) to prevent damages;
said integrated position feedback system detects the position of plunger (40) based on the magnetic field fluctuations sensed by the hall sensor that take place after the plunger (40) and the permanent magnet (36) incorporated inside the plunger (40) moves through stroke length when the coil (28) is energized or de-energized;
said hall sensor senses the fluctuation of magnetic field and provides a feedback signal in form of voltage that indicates position of plunger and indicate a plurality of operating modes of solenoid valve (10).

2. The solenoid valve (10) as claimed in claim 1 wherein, the plurality of operating modes of solenoid valve (10) indicated are: ON state with full rated voltage; Off state with lower rated voltage; Defined stroke state with any rated voltage between full rated voltage and lower rated voltage; and Failure state with least voltage.

3. The solenoid valve (10) as claimed in claim 1 wherein, said poppet (18) has plurality of flat surface (18a) and (18c) across its length to assist in venting of air pocket locked inside solenoid valve.

4. The solenoid valve (10) as claimed in claim 1 wherein, said stroke length is the distance that the plunger travels in one cycle.

5. The solenoid valve (10) as claimed in claim 1 wherein, said rubber grommet is provided for mounting the solenoid valve (10).

6. The solenoid valve (10) as claimed in claim 1 wherein, in said bobbin sub-assembly (22), the coil (28) is wrapped around bobbin (26) and is put inside said magnetic bracket (32) and crimped to fix core plate (30) to provide a magnetic path.

7. The solenoid valve (10) as claimed in claim 1 wherein, in said bobbin sub-assembly (22) the plurality of terminal pins (34) are connected at one end of bobbin (26) to which the coil's (28) end are connected.

8. The solenoid valve (10) as claimed in claim 1 wherein, said permanent magnet (36) is incorporated inside the plunger (40) by press fitting the magnet holder (38) to the plunger (40).

9. The solenoid valve (10) as claimed in claim 1 wherein, said soft seal (44) protects the sensor sub-assembly from vibration and external environmental damages.

10. The solenoid valve (10) as claimed in claim 1 wherein, said sensor sub-assembly is programmable to receive the feedback signal as per requirement i.e. not limited to a fixed magnitude.
